(19) United States
(12) Patent Application Publication
(10) Pub. No.: US 2018/0343886 A1
(43) Pub. Date: Dec. 6, 2018

(54) FLOSS-LIKE CRYSTALLINE STRUCTURES WITH COUPLED CRYSTAL STRUCTURES AND METHODS OF MAKING SAME

(71) Applicant: Chris Lingel, Ramona, CA (US)

(72) Inventor: Chris Lingel, Ramona, CA (US)

(21) Appl. No.: 15/997,696

(22) Filed: Jun. 5, 2018

Related U.S. Application Data
(60) Provisional application No. 62/515,446, filed on Jun. 5, 2017.

(51) Int. Cl. A23G 3/54; A23G 3/34

(52) U.S. Cl. CPC A23G 3/54; A23G 3/0051

(57) ABSTRACT

Embodiments of a product including floss-like crystalline structures with coupled crystal structures and methods of producing same. Other embodiments may be described and claimed.

### TECHNICAL FIELD

Various embodiments described herein relate generally to floss-like crystalline structures, including methods for producing floss-like crystalline structures.

### BACKGROUND INFORMATION

It may be desirable to produce floss-like crystalline structures with coupled crystal structures.

### BRIEF DESCRIPTION OF THE DRAWINGS

FIG. 1A is a simplified diagram of a product including floss-like crystalline structures with coupled crystal structures coupled to a cone according to various embodiments.

FIG. 1B is a simplified diagram of a product including floss-like crystalline structures with coupled crystal structures stored in a cylindrical container according to various embodiments.

FIG. 2 is an enlarged, simplified diagram of floss-like crystalline structures with coupled crystal structures according to various embodiments.

FIG. 3A-3C are flow diagrams illustrating algorithms for producing a product including floss-like crystalline structures with coupled crystal structures according to various embodiments.

### DETAILED DESCRIPTION

In an embodiment, it may be desirable to produce floss-like crystalline structures with coupled crystal structures. In an embodiment, the floss-like crystalline structure (FLCS) may be formed from edible substances that may be formed into floss-like crystalline structures. Further, the edible substances may be formed into floss-like crystalline structures when heated to a melting point, extruded into floss-like threads, and cooled to the edible substance's crystallization point temperature.

In an embodiment, an edible substance may include various sugars and sugar alcohols. The sugars may include sucrose, glucose, fructose, or combinations thereof. The sugar alcohols may include arabitol, erythritol, glycerol, isomalt, lactitol, maltitol, mannitol, sorbitol, xylitol, sucrose, or combinations thereof. In an embodiment, the edible substance may include a combination of sugars and sugar alcohols. Any of these combinations when employed to form floss-like crystalline structures may be termed “cotton candy or fairy floss”. In an embodiment, any of these combinations may be heated to a melting point, extruded into floss-like threads, and cooled to the edible substance's crystallization point temperature to form floss-like crystalline structures (FLCS).

In an embodiment, other crystal or crystalline structures may be desirably coupled with the FLCS to provide other features and attributes to the FLCS. The other crystalline structures may include flavonoids, artificial flavors, medicants, or other structures that may desirably couple with the FLCS. In an embodiment, the crystal structure(s) (to be coupled) may have a lower melting or disassembly point than the crystal or crystalline material(s) that form the FLCS and may become part of the FLCS. In another embodiment, the crystal structure(s) (to be coupled with the FLCS) may have a smaller average particle size than the crystal or crystalline material(s) that form the FLCS and become adhered to the FLCS or become part of the FLCS as a function of their respective melting points.

In a further embodiment, the crystal structure(s) to be coupled may have a smaller average particle size and higher melting or disassembly point than the crystal material that forms the FLCS 12 and thus become adhered to the FLCS 12 as it is formed via melting or disassembly. As noted, in an embodiment, the crystal material(s) to be coupled to the FLCS 12 may include medicants. The medicants may include peptides, growth factors, and crystals or trichomes harvested or produced from cannabis plants or buds. The growth factors may be a naturally occurring substance capable of stimulating cellular growth. Crystals or trichomes harvested or produced from cannabis plants or buds may include one of the over 100 cannabinoids such as Tetrahydrocannabinol (THC), Cannabidiol (CBD), Cannabinol (CBN) crystals, or combinations of any of the over 100 cannabinoids.

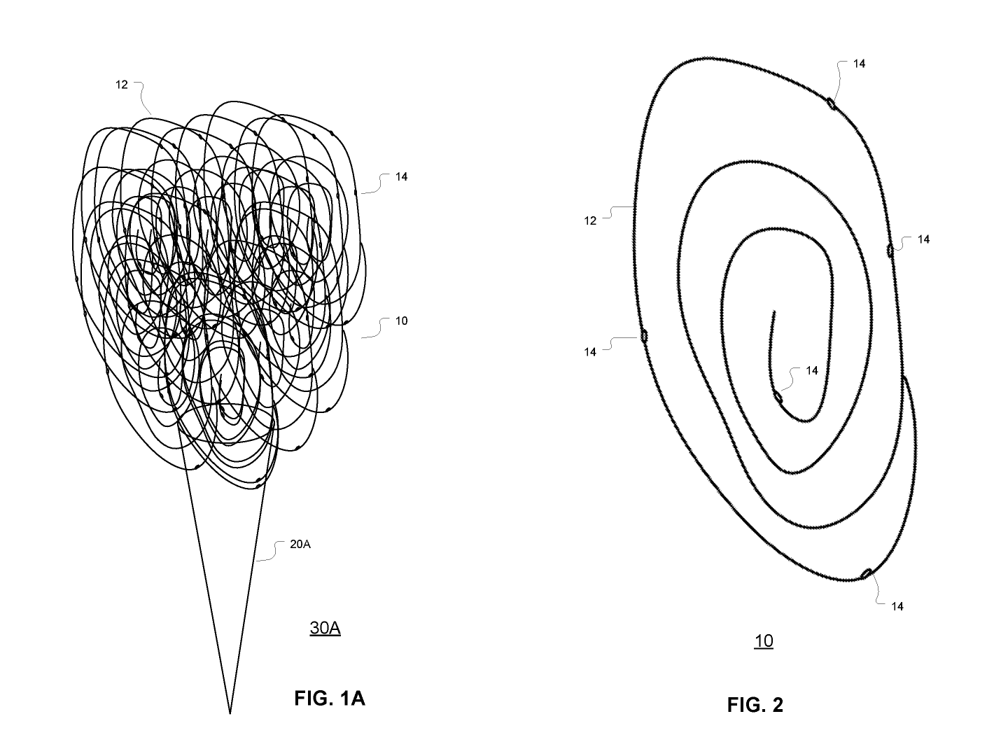

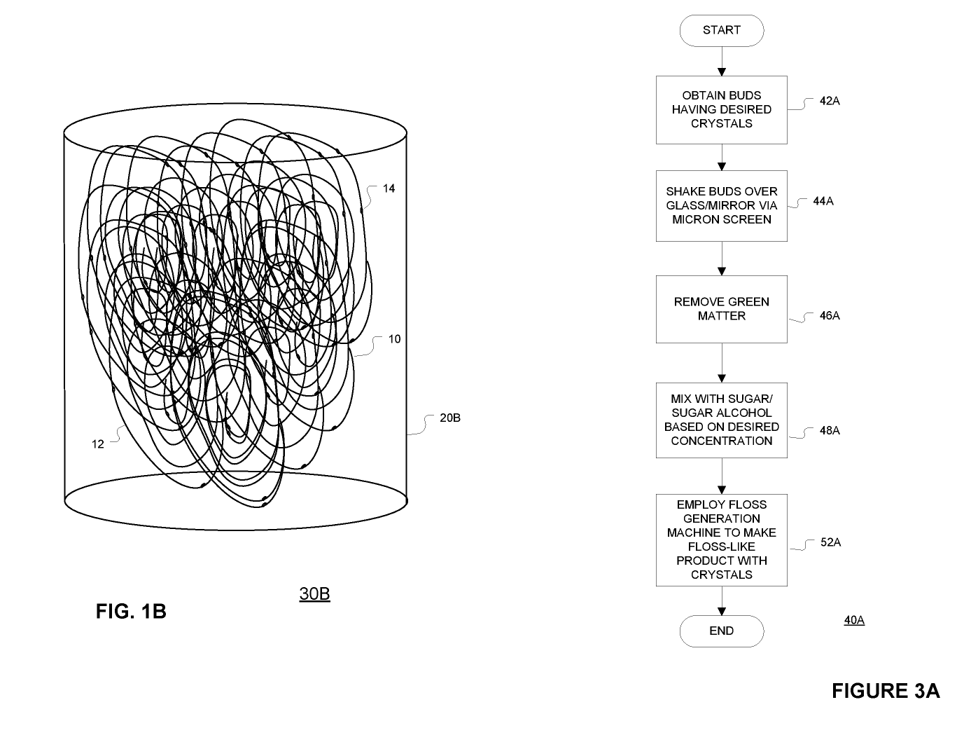

FIG. 1A is a simplified diagram 30A of a product 10 including floss-like crystalline structures 12 with coupled crystal structures 14 coupled to a cone 20A according to various embodiments. FIG. 1B is a simplified diagram 30B of a product 10 including floss-like crystalline structures 12 with coupled crystal structures 14 stored in a cylindrical container 20B according to various embodiments. FIG. 2 is an enlarged, simplified diagram of a product 10 including floss-like crystalline structures 12 with coupled crystal structures 14 according to various embodiments. As noted in an embodiment, the FLCS 12 may be formed from sugar or sugar alcohol compounds. In an embodiment, the adhered crystal structures 14 may include medicants. The number of crystal structures 14 relative to FLCS 12 may be varied as a function of the desired concentration of crystal structures.

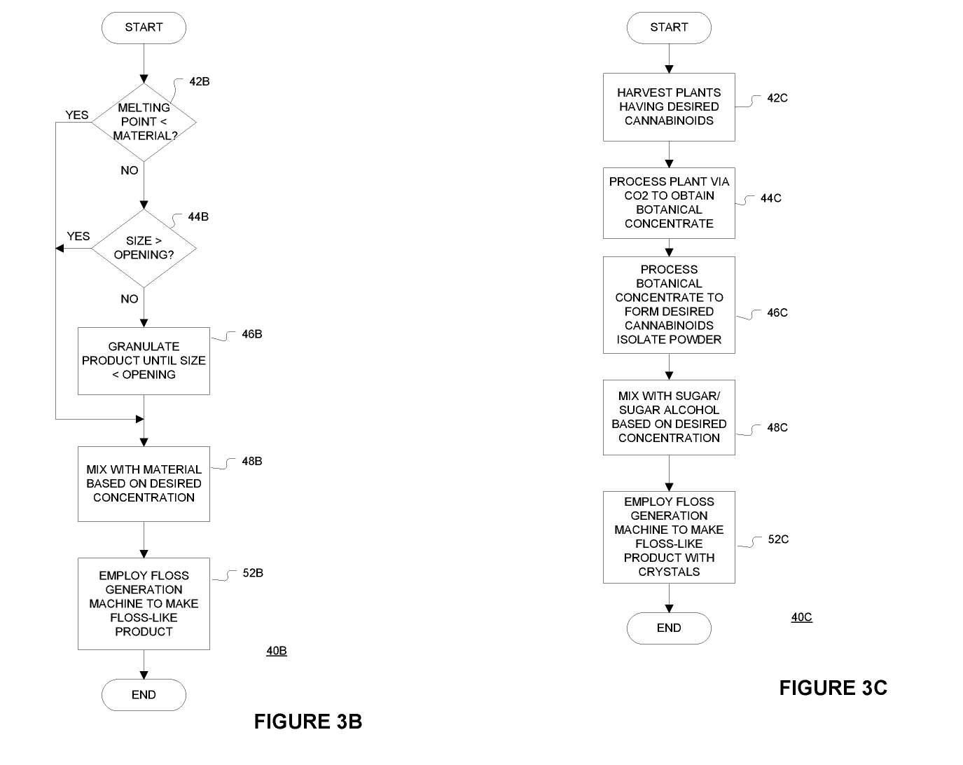

FIGS. 3A-3C are flow diagrams illustrating algorithms 30A, 30B, 30C for producing a product 10 including floss-like crystalline structure(s) 12 with coupled crystal structures 14 where the crystal structures 14. In an embodiment, crystal structures 14 may be adhered to the FLCS 12. In an embodiment, crystal structures 14 may melded with the FLCS 12. In an embodiment, crystal structures 14 may adhered to and melded with the FLCS 12. FIGS. 3A and 3B are flow diagrams illustrating algorithms 40A-B for producing particular FLCS 12 with coupled crystal or powder structures 14. In algorithm 40A shown in FIG. 3A, the crystal structures 14 are derived of harvested directly from a plant. In algorithm 40B shown in FIG. 3B, the crystal or powder structures 14 may be formed from a plant including a cannabis plant such as a hemp plant in an embodiment.

In an embodiment, the product 10 may include sugar or sugar alcohol (or combinations thereof) based floss-like crystalline structures (FLCS) 12 with coupled crystal cannabinoids structures 14 according to various embodiments. FIG. 3B is a flow diagram illustrating an algorithm 40B for producing a product 10 including floss-like crystalline structures 12 coupled with one or more crystal structures 14 according to various embodiments such as crystal structures or powders 14 produced in algorithm 40A, 40B.

As shown in FIG. 3A, in algorithm 40A, a cannabis plant having buds may be harvested. The one or more cannabinoid crystals may be harvested or obtained from one or more cannabis buds (activity 42A). In an embodiment, the buds may have one or more cannabinoid crystals or combinations thereof such as desired Tetrahydrocannabinol (THC), Cannabidiol (CBD), Cannabinol (CBN) crystals. The cannabinoids may be separated from the buds to produce primarily crystals 14 with little or no green matter. In an embodiment, the harvested buds including desired crystals may be shaken over a glass/mirror via a micron mesh screen (activity 44A) to collect desired cannabinoid crystals 14. Green matter, if present may be removed from the crystals 14 (activity 46A). In an embodiment, the micron mesh screen may have openings that enable crystals having a particle size smaller than the sugar, sugar alcohol or combinations thereof material particles and smaller than the openings of ribbons or spinner of a floss generation machine to pass therethrough.

As shown in FIG. 3C, in algorithm 40C, plants having desired cannabinoids may be harvested (activity 42C) including hemp plants. In an embodiment, the harvested plants may contain more than 100 cannabinoids including cannabidiol (CBD), cannabinol (CBN), cannabicyclol (CBL), tetrahydrocannabivarin (THCV), and cannabichromevarinic acid (CBCVA). In an embodiment, the harvested plants may be processed to produce high purity cannabinoid powders or crystals 14 (activities 44C, 46C). In an embodiment, the harvested plant may be processed with CO2 (carbon dioxide) to produce a botanical concentrate (activity 44C). The botanical concentrate may be processed/filtered to obtain desired cannabinoid isolate powders or crystals (activity 46C). In an embodiment, the resultant isolate powders may have a particle size smaller than the sugar, sugar alcohol or combinations thereof particles and smaller than the openings of ribbons or spinner of a floss generation machine to pass therethrough.

In an embodiment, the sugar, sugar alcohol or combinations thereof material 12 may have an average particle size greater than 250 to 500 microns and about 400-500 microns in an embodiment. In an embodiment, a floss generation machine may have ribbons or a spinner with openings that permit particles smaller than 250 microns to pass therethrough. In an embodiment, crystals 14 having nanometer sizes may be employed to be coupled with FLCS 12.

In an embodiment, the collected or produced cannabinoid crystals 14 may then be combined with sugar, sugar alcohol or combinations thereof material and other flavor and color elements to form a mixture (activities 48A, 48C) to be processed by a floss generation machine. In an embodiment, the mixture may include about 500 mg to 800 mg of cannabinoid crystals per 10 to 100 grams or about 28.3 grams (about an ounce) of sugar, sugar alcohol or combinations thereof material or about 1.7 to 2.8 percent cannabinoid crystals to sugar, sugar alcohol or combinations thereof material/crystals. In another, stronger embodiment, the mixture may include about 1000 mg to 1750 mg of cannabinoid crystals per 10 to 100 grams or about 28.3 grams of sugar, sugar alcohol or combinations thereof material or about 3.5 to 6.2 percent cannabinoid crystals to sugar, sugar alcohol or combinations thereof material/crystals.

Once the desired mixture is obtained, a floss generation machine may be employed to create the product 10 shown in FIGS. 1A and 1B. For a mixture including a mixture of sugar, sugar alcohol or combinations thereof crystals and cannabinoid crystals, the floss generation machine may be set to operate at a temperature of about 320 to 340 degrees Fahrenheit. Cannabinoid crystals may have a melting point or disassembly temperature greater than the sugar, sugar alcohol or combinations thereof crystals. For Example, Tetrahydrocannabinol (THC), Cannabidiol (CBD), Cannabinol (CBN) crystals may have a melting point of about 392F, 365F, and 365F, respectively. In an embodiment, the floss generation machine may be a standard cotton candy machine.

The resultant product 10 may be coupled to a cone 20A or stored in cylindrical container 20B in an embodiment. In general, any product 10 including floss-like crystalline structures 12 with adhered crystal structures 14 or including floss-like crystalline structures 12 melded with crystal structures 14 may formed via the algorithm 40B shown in FIG. 3B or a combination of both. When the melting point or disassembly point of the crystals 14 is less than or equal to the material used primarily to generate the flow-like structures 12 (activity 42B), the crystals 14 may be added directly to the material to form a mixture (activity 48B). In such an embodiment, the product 10 may have limited or no adhered structures 14 since the added crystals 14 may melt or meld together with the main material (such as sugar, sugar alcohols, or combinations thereof) and form only floss-like crystalline structures including the main material 12 and the crystals 14 when processed by a floss generation machine (activity 52B).

When the melting point or disassembly point of the crystals 14 is greater than the material used primarily to generate the flow-like structures 12 (activity 42B), the crystals 14 may be added directly to material 12 to form the mixture (activity 48B) when its particle size is less than the floss generation machine ribbon or spinner opening(s) (activity 44B). Otherwise, the crystals 14 to be adhered to the FLCS 12 may be granulated until its particle size is smaller than the floss generation machine ribbon or spinner opening(s) (activities 44B, 46B). In either case, the crystals 14 (or granulated crystals) may be added to the main material 12 to form a mixture (activity 48B). A floss generation machine may then be employed to produce the product 10 with FLCS 12 and adhered crystals structures 14.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A floss-like crystalline product including:
a heat extruded floss-like crystalline structure formed by heating a meltable crystalline material to a temperature greater than its melting point and extruding the heated meltable crystalline material through a screen having a minimal pore size; and
a plurality of crystalline structures adhered to the heat extruded floss-like crystalline structure, each of the plurality of crystalline structures having a melting point greater than the melting point of the meltable crystalline material and having a diameter less than screen's minimum pore size.

2. The floss-like crystalline product of claim 1, wherein the crystalline material and the plurality of crystalline structures are edible.

3. The floss-like crystalline product of claim 2, wherein the crystalline material includes one of sugars, sugar alcohols, and a combination of sugars and sugar alcohols.

4. The floss-like crystalline product of claim 2, wherein the crystalline material includes sugars.

5. The floss-like crystalline product of claim 2, wherein the crystalline material includes sugar alcohols.

6. The floss-like crystalline product of claim 5, wherein the sugar alcohols include isomalt.

7. The floss-like crystalline product of claim 2, wherein the plurality of crystalline structures includes one of medicants and flavonoids.

8. The floss-like crystalline product of claim 2, wherein the plurality of crystalline structures includes cannabinoids.

9. The floss-like crystalline product of claim 2, wherein the plurality of crystalline structures includes one of cannabidiol and cannabinol.

10. The floss-like crystalline product of claim 3, wherein the plurality of crystalline structures includes one of cannabidiol and cannabinol.

11. A floss-like crystalline product including a heat extruded floss-like crystalline structure formed by heating a meltable crystalline material with a plurality of crystalline structures to a first temperature greater than the melting point of the crystalline material and each of the plurality of crystalline structures and extruding the heated meltable crystalline material and the plurality of crystalline structures through a screen having a maximum pore size, the meltable crystalline material and each of the plurality of crystalline structures having a diameter greater than the screen's maximum pore size.

12. The floss-like crystalline product of claim 11, wherein the crystalline material and the plurality of crystalline structures are edible.

13. The floss-like crystalline product of claim 12, wherein the crystalline material includes one of sugars, sugar alcohols, and a combination of sugars and sugar alcohols.

14. The floss-like crystalline product of claim 12, wherein the crystalline material includes sugars.

15. The floss-like crystalline product of claim 12, wherein the crystalline material includes sugar alcohols.

16. The floss-like crystalline product of claim 15, wherein the sugar alcohols include isomalt.

17. The floss-like crystalline product of claim 12, wherein the plurality of crystalline structures includes one of medicants and flavonoids.

18. The floss-like crystalline product of claim 12, wherein the plurality of crystalline structures includes one of peptides and growth factors.

19. The floss-like crystalline product of claim 12, wherein the plurality of crystalline structures includes growth factors.

20. The floss-like crystalline product of claim 13, wherein the plurality of crystalline structures includes one of peptides and growth factors.
